(19) United States
(12) Patent Application Publication
(10) Pub. No.: US 2024/0370898 A1
(43) Pub. Date: Nov. 7, 2024

(54) SELF-LEARNING SYSTEMS AND METHODS FOR DIGITAL CONTENT SELECTION AND GENERATION USING GENERATIVE AI

(71) Applicant: Accenture Global Solutions Limited, Dublin (IE)

(72) Inventors: Piyush Vakil, Newark, DE (US); Mohit Jain, Gurugram (IN); Jeannette Park, Anaheim, CA (US); Abhishek Gupta, Gurugram (IN); Saumya Kharya, New Delhi (IN); Vlad Kucherovsky, Overland Park, KS (US)

(21) Appl. No.: 18/311,467

(22) Filed: May 3, 2023

(51) Int. Cl. G06Q 30/0242; G06N 5/022; G06Q 30/0204; G06Q 30/0251

(52) U.S. Cl. CPC G06Q 30/0244; G06N 5/022; G06Q 30/0204; G06Q 30/0269

(57) ABSTRACT

Systems and methods for generating digital content and selecting targets for presentation of digital content using artificial intelligence are disclosed. In one example, a nanosegment of customers can be selected as targets for digital content based on their propensity to accept offers for a given campaign. By incorporating a nanosegment-based classification of customers, there can be significantly reduced memory usage by the system, since the customer base will be reduced to a fewer number of groups, and each group more specifically targets traits for one cluster of customers. Attributes of the selected customers can be used to automatically design and generate digital content, such as personalized offers for distribution to the customers, including AI-generated taglines, content, and images. Feedback from each cycle of the campaign can be fed back into subsequent cycles to continuously improve performance and offer outcomes.

### TECHNICAL FIELD

The present disclosure generally relates to the field of generating and presenting digital content, and more specifically, to systems and methods for optimizing the generation and presentation of digital content for different consumers using generative artificial intelligence techniques.

### BACKGROUND

Many businesses utilize a campaign process to deliver marketing offers to a variety of consumers. Campaigns may be conducted, for example, by online advertising, telephone, e-mail, texts, or by mass mailing. In order to define the campaigns to execute, the business may gather and aggregate information about their customers from a variety of data sources, both from within their company as well as from third party data providers. After gathering the consumer information, the businesses may decide to separate customers into groupings, customer segments, which have similar characteristics. The businesses may then create a specific list of consumers that the businesses hope will respond positively to the campaign. Sometimes, these lists may be produced using generalized marketing response models—models developed on generalities about the firm's customers rather than specifics about likely customer response to forthcoming campaign offers. In other cases, the lists are purchased from third-party vendors, or extracted from internal databases. This process typically can be time consuming and deliver sub-optimal results.

Propensity models (models comparing attributes of prospect lists to attributes of existing customers) are often developed by businesses and used to develop targeting lists of persons who look like existing customers—and hence may have a greater propensity to respond to the business' marketing campaigns. However, the time-consuming conventional modeling and marketing processes cannot support rapid test and learn iterations that could ultimately improve offer acceptance rates, nor do they allow for hyper-personalized offer targeting or real-time improvements to the campaign. It can be a challenge to continuously fine-tune the targeting of offers for marketing campaigns. Yet such fine-tuning can be necessary in order to maintain or improve customer conversion rates and campaign profitability, while also limiting customer campaign fatigue.

There is a need in the art for a system and method that addresses the shortcomings discussed above.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic diagram of a high-level overview of a campaign optimization framework, according to an embodiment;

FIGS. 2, 3, 4, 5, and 6 are schematic diagrams of sections of a process through a campaign optimization system, according to an embodiment;

FIG. 7 is an example of a cyclical selection process by which customers are identified and assigned to nanosegments for offer targeting, according to an embodiment;

FIG. 8 is a flow chart depicting a method for generating digital content by generation of hyper-targeted offers, according to an embodiment; and

FIG. 9 is a diagram depicting example environments and components by which systems and/or methods, described herein, may be implemented.

### SUMMARY

Systems and methods for generating digital content and selecting targets for presentation of digital content using artificial intelligence are disclosed Implementations described herein provide hyper-targeted offer optimization systems and methods that incorporate historical campaign data to optimize and retarget campaign contact strategies. The system includes a self-learning system which optimizes based on campaign objectives such as cost, desired conversion, and customer experience to drive offers, targeting, and content to a smaller customer base. This improves the propensity that customers will positively respond to campaigns during marketing cycles while enabling explainability and transparency for end-users. In some embodiments, the system optimizes targeting based on real-time learnings or insights for both the contact strategy and propensity of acceptance. Based on the customer's curated attributes, an offer that includes tailored content, taglines, and imagery can be automatically generated using generative artificial intelligence techniques, significantly increasing the likelihood of a positive outcome for each customer's interaction with the campaign offer, and thereby improving customer experience, retention, and conversion events (causing a potential customer to become an actual customer). By incorporating a nanosegment-based classification of customers, there can be significantly reduced memory usage by the system, since the customer base will be reduced to a fewer number of groups, and each group more specifically targets traits for one cluster of customers.

In one aspect, the disclosure provides a computer-implemented method for generating digital content. The method includes a first step of receiving, by a processor, a first optimization objective for a first campaign and access to customer information, and a second step of segmenting, at the processor, customers identified in the customer information into a plurality of nanosegments using a cluster analysis algorithm that identifies clusters in the customer information based on similar characteristics and predefined rules. A third step includes selecting, by a machine learning (ML) optimization model and based on the first optimization objective, a first set of nanosegments from the plurality of nanosegments for inclusion in the first campaign. A fourth step includes passing, from the processor, the first set of nanosegments to a first generative artificial intelligence (AI) component, and a fifth step includes automatically generating, via the first generative AI component, digital content including a first element for a first offer in response to the customer information for only the first set of nanosegments, the first element including one of a tagline, image, and content. The method also includes a sixth step of providing, to a first client computing device, first data that causes the first client computing device to present a visual representation of the first element as part of the first offer, the first client computing device being associated with a first customer identified in the first set of nanosegments.

In another aspect, the disclosure provides a non-transitory computer-readable medium storing software comprising instructions for generating digital content executable by one or more computers which, upon such execution, cause the one or more computers to: (1) receive, by a processor, a first optimization objective for a first campaign and access to customer information; (2) segment, at the processor, customers identified in the customer information into a plurality of nanosegments using a cluster analysis algorithm that identifies clusters in the customer information based on similar characteristics and predefined rules; (3) select, by a machine learning (ML) optimization model and based on the first optimization objective, a first set of nanosegments from the plurality of nanosegments for inclusion in the first campaign; (4) pass, from the processor, the first set of nanosegments to a first generative artificial intelligence (AI) component; (5) automatically generate, via the first generative AI component, digital content including a first element for a first offer in response to the customer information for only the first set of nanosegments, the first element including one of a tagline, image, and content; and (6) provide, to a first client computing device, first data that causes the first client computing device to present a visual representation of the first element as part of the first offer, the first client computing device being associated with a first customer identified in the first set of nanosegments.

In another aspect, the disclosure provides a system for generating digital content. The system comprises one or more computers and one or more storage devices storing instructions that are operable, when executed by the one or more computers, to cause the one or more computers to: (1) receive, by a processor, a first optimization objective for a first campaign and access to customer information; (2) segment, at the processor, customers identified in the customer information into a plurality of nanosegments using a cluster analysis algorithm that identifies clusters in the customer information based on similar characteristics and predefined rules; (3) select, by a machine learning (ML) optimization model and based on the first optimization objective, a first set of nanosegments from the plurality of nanosegments for inclusion in the first campaign; (4) pass, from the processor, the first set of nanosegments to a first generative artificial intelligence (AI) component; (5) automatically generate, via the first generative AI component, digital content including a first element for a first offer in response to the customer information for only the first set of nanosegments, the first element including one of a tagline, image, and content; and (6) provide, to a first client computing device, first data that causes the first client computing device to present a visual representation of the first element as part of the first offer, the first client computing device being associated with a first customer identified in the first set of nanosegments.

The predefined rules may include threshold values and/or other constraints.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### DESCRIPTION OF EMBODIMENTS

The proposed systems and methods are directed to the management of contact strategies using self-learning machine learning models (MLs) and generative artificial intelligence (AI) with the goal of accurately predicting a person's response propensity to a particular marketing campaign style and contact channel and generating and presenting the most suitable offer to that person. Results of each cycle of a given campaign can be fed back into the system and used to re-analyze predictions of customer behavior and improve the types of offers that should be generated to optimize campaign performance.

An organization's capacity to execute an effective self-learning (feedback loop) process to tailor their marketing campaigns affects all forms of customer interaction. In striving to improve customer experience, organizations seek to deliver the right message to the right customer through the best channel for that customer. The proposed systems and methods allow businesses to quickly generate—using generative AI techniques—hyper-targeted offers for customers based upon predictive analytical models and refined through rapid test and learn iterations, enabling delivery of optimized marketing offers tailored to their customers and prospects across all forms of customer interactions. Customers who are selected as targets of an outbound marketing campaign can thereby receive the most suitable, personalized offer that has the highest likelihood of successfully promoting the campaign objectives.

As noted earlier, businesses often seek to tailor their service and product offerings to the needs of their customer to improve their performance outcomes. In some cases, businesses have relied on customer segmentation and association rules to guide their sales and service strategies. As a general matter, customer segmentation balances the goal of providing personalized experiences with the ability to profitably scale. This approach, as implemented by the proposed systems, significantly improves customer experiences by enabling real-time offer customization using generative AI that is based on each customer's attributes and predicted interests. Customers are more likely to have a positive response to seeing offers that carry content that match their interests. A framework by which each nanosegment—or even each individual customer—can be presented an offer that is tailored to their profile is thereby highly desirable. The proposed embodiments can generate individualized offers that are crafted using generative AI models to automatically output the most effective ad for a given user or user type.

For purposes of this application, segmentation refers an approach by which an entity seeks to identify similar groups of target customers based on certain attributes of the target customer. As some non-limiting examples, businesses may perform demographic segmentation on customers, identifying “single males between 20-30 years of age,” or categorical segmentation, labeling customers as “bargain hunters” or “upper echelon.” Furthermore, association rules seek to identify related customer behavior, for example, customer purchasing habits or trends (e.g., by looking at purchase history data of customers the system may correlate or otherwise associate the purchase of one product with another and may use this information to predict future purchase behavior of a particular customer).

However, it can be appreciated that nanosegmentation is generally only effective on large populations where observational data for a given parameter exists for each member of the population. But such data may not always be available, or may be obtained at a high cost. Moreover, traditional segmentation does not confer genuine personalization as it fundamentally relies on approximating a customer's preferences based on the preferences of a much broader population segment. Similarly, association rules may only provide limited insight regarding customer behavior and tend to more simply reinforce existing customer behaviors. These issues are particularly significant in today's digital era, where customers are deeply connected through social media, highly informed via the internet, and constantly on-the-go with the ability and desire to access information using mobile computing devices. The practice of distilling large numbers of customers into broad or generalized sub-categories or buckets using static customer relationship management information, often based on one-time transactions in a traditional purchase paradigm, is no longer sufficient.

As will be discussed in greater detail below, the proposed embodiments can provide a self-sustaining, self-learning marking operations system that optimizes (e.g., based on desired objectives such as cost, conversion, and customer experience) to drive offers targeting and content to the customer base using generative AI techniques. In different embodiments, the system is arranged to facilitate transparency by incorporating explainability features and components. In one example, optimization can be based on real-time learnings and insights across both a context strategy and the customer's propensity of acceptance. In some embodiments, the system employs a two-stage optimization strategy which can ensure optimal targeting of both cost and offers.

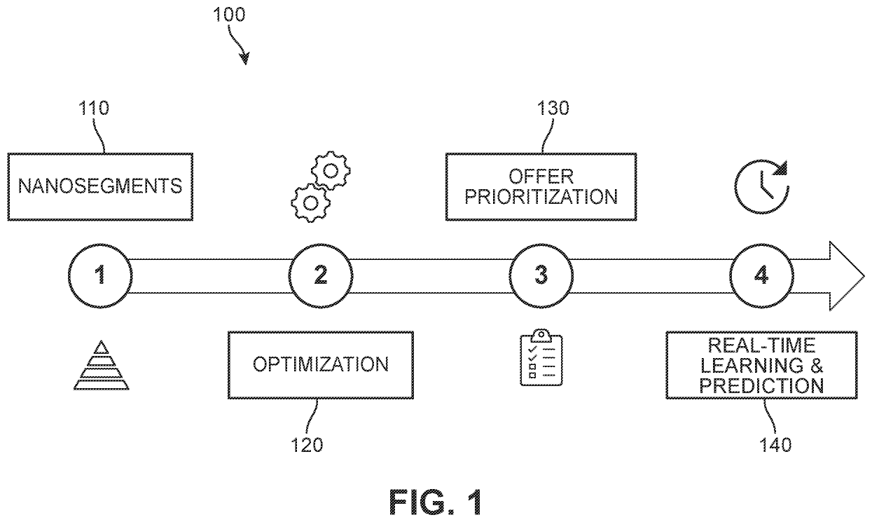

The proposed embodiments thereby provide an alternate approach to provide for highly effective targeting marketing campaigns. As an introduction, FIG. 1 identifies some examples of advantageous concepts/layers or features offered by the proposed systems and methods. In FIG. 1, in some embodiments, a first feature 110 of a campaign offer optimization system (“system”) is based on an ML and rules driven process used to determine and generate nanosegments of consumers. As noted above, industries typically have used a large broad customer base to determine customer levels, conventionally associated with a ‘black box’ type arrangement with little to no explainability.

In contrast, nanosegmentation can refer to an approach by which the system can discern or reveal heterogeneous customer preferences (i.e., providing a much finer-grained market segmentation). In some embodiments, the nanosegments are developed using a unique combination of AI and a repository describing a specific set of rules and attributes associated with the customer experiences. By incorporating a nanosegment-based classification, there can be significantly reduced memory usage by the system, since the customer base will be reduced to a fewer number of groups, and each group more specifically targets traits for one cluster of customers. In one example, the system can differentiate and identify at least 80-100 nanosegments that may be potentially targeted for a given campaign, though in other embodiments, the number of nanosegments can vary. The use of nanosegments can further reduce the system's estimated processing or run time; in one example, the system performed with a 40-50% decrease in run time. Furthermore, nanosegments increases decision-making transparency, allowing the system to present insights into why a specific customer or set of customers were targeted with the selected content, and why a different customer was not, which can contribute to the decrease in run time. With such explainability-driven insights, businesses may develop a more meaningful understanding of individual customer needs, preferences, and lifestyles. Businesses may also use the nanosegment-based data to convert insights into actions, for example, inferring future product and service needs, or personalizing offers to individual customers as they shop online or via their mobile device. In this way, businesses may leverage this information to better satisfy customer demands, strengthen brand loyalty and drive sales, and from the customers' perspective, this results in a personalized and effortless consuming experience as they go about their daily lives. Businesses may also use explainability insights to suggest new products and services just outside a customer's comfort zone, or generate upselling opportunities that may enhance the customer experience and advance certain business goals.

In some embodiments, the system further operates with a second feature 120 that provides customer-level optimization within each nanosegment. In other words, the system can assess what specific customers within the designated nanosegments should be targeted based on determinations/predictions of how consumers are most likely to respond to marketing offers. In some cases, this is a repetitive step; for example, the assessment can be re-run more or less frequency based on business needs, and provide a refined target from the initial stage with minimal historical data. In different embodiments, optimization objectives can be set by the system to optimize for cost, as well as for event acceptance levels once the customer data is collected or created. In some embodiments, AI propensity models are used to identify the high-propensity customers within nanosegments, thus further refining the targeted base. In one example, an ML-driven optimization algorithm can be run on the nanosegments, with an initial focus on the “cost” optimization. In some embodiments, the system can be used to optimize for customer conversion propensity as well.

A third feature 130 includes offer prioritization, whereby the system can determine—in cases where a customer is eligible for multiple offers—how or in what order the offers should be prioritized in order to most effectively target the customer for optimal conversion and campaign cost optimization. In some embodiments, offer prioritization can be driven by one or more adaptive self-learning AI models, AI propensity models, and/or object driven algorithms that prioritize offers in those cases where a particular customer is targeted with two or more offers or campaigns, for example based on campaign cost optimization, optimal offer conversion propensity, and/or customer experience optimization, thereby enhancing the targeting outcome and fine-tuning the contact strategy.

Finally, a fourth feature 140 of the system can include a capacity for real-time learning and prediction using guided generative AI. For example, once the system has identified a nanosegment and identified specific customers in that nanosegment using optimization, as well as selected the most effective offer that should be prioritized, the system can determine what content should be presented that will best take advantage of the customer's predicted propensity. In some embodiments, processing models are employed that ingest historical and real-time performance data, creating a guided input for generative AI models to form offer presentation components based on the information. More specifically, these AI-generated components can include one to three presentation elements or features, such as tagline, image, and body content, that are tailored and hyper-targeted for the given scenario/customer to best sustain the customer's engagement. In some embodiments, the system can employ a continuous feedback loop that has been shown to incrementally improve model accuracy by approximately 5-8%, and reduce customer opt-out rates from various communication channels by approximately 5-6%. Furthermore, language learning models (LLMs) can be employed to produce autogenerated taglines and content from prior campaigns that can for example increase campaign incrementality by at least 100 basis-points and facilitate a hyper-personalization of offers.

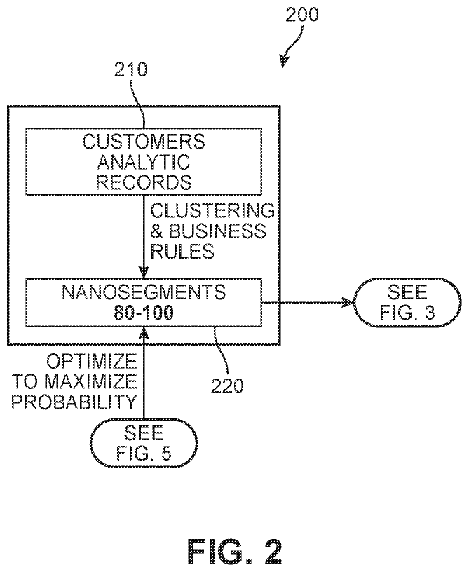

As discussed above, in different embodiments, the proposed systems can comprise a plurality of layers or modules by which each of the above features depicted in FIG. 1 can be generated and/or managed. Additional details regarding the system architecture and each layer will now be provided with reference to FIGS. 2-6. Referring first to FIG. 2, a first module 200 (also referred to herein as the nanosegment layer) of an embodiment of the campaign offer optimization system (“system”) is illustrated. The first module 200 is directed to the designation of a plurality of nanosegments 220 based on specific customer-related inputs, such as customer analytic records (“CAR”s) 210. In different embodiments, a CAR may be used as input to descriptive and predictive models to determine how consumers are likely to respond to marketing offers. The models may also be used to predict a likelihood of attrition or other behaviors.

In some embodiments, CAR data may include identification and behavior fields. The identification fields may be for household information such as a household identifier, address, and phone number and household individual information such as name and electronic mail address. The behavior fields summarize transaction information and contain statistical transformation of this data for analytical use. Examples include account summary data, ratio to mean and z-score calculations, moving average and moving difference calculations over a specified period of time, log transformations and slope calculations. In some embodiments, the CAR may also include demographic fields. The demographic fields may include, for example, income level and house size. The demographic fields also include fields pertaining to lifestyle and interest. The lifestyle fields may include, for example, whether the individual is a domestic, enjoys the outdoors such as hiking, biking, camping, walking, running, etc., and whether the individual is athletic or enjoys sports. The interest fields may indicate, for example, whether the individual likes to travel, play video games, drink wine, play sports, watch sports, read, etc. Preferably, each of the fields and data included in the CAR may be cross-referenced to an individual's household. This may be performed by linking a household identifier to an individual's identifier. In another example, the CAR may also include a contact history. The contact history may include information related to promotions offered to a customer, promotions redeemed by the customer, elapsed time for the offer to be redeemed, and telephone calls made or emails sent to the customer by a contact center or received from the customer by a contact center. The contact center may be, for example, an on-line support system, a sales representative center, etc. In addition to identification fields, behavior fields, demographic fields, and contact history fields, the CAR can also include fields representing product ownership information. Product ownership can refer to a listing of all of the products and services that a customer has previously purchased from the business. Such product ownership information in the CAR record provides a more complete picture of each customer and may be used in determining which offers to extend to certain customer segments.

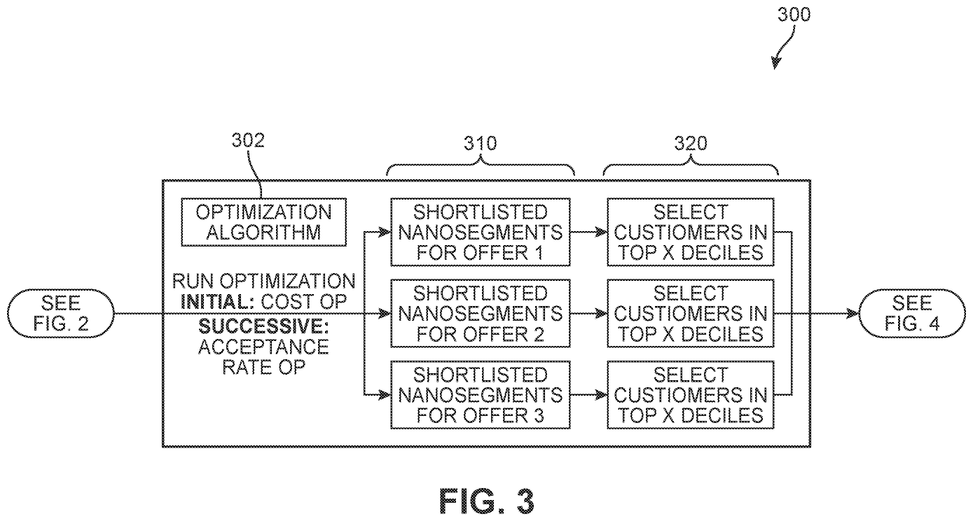

In some embodiments, customer analytic records can be pre-processed using clustering techniques and industry-dependent rules. The rules may include threshold values and/or other constraints. In some embodiments, segmentation may be performed by using a cluster analysis algorithm to identify latent clusters in the data. For example, a clustering algorithm can identify clusters that have a low ratio of within-cluster variability to across-cluster variability using some standard distance metrics, thereby generating clusters that are more closely aligned with the target campaign optimization objective. In one embodiment, the selected rules can shape what customer profile will be created as the basis of each nanosegment. This initial clustering and nanosegmentation defines highly nuanced customer groupings that can be used to augment and enhance the outcome for each of the subsequent operations (e.g., see FIGS. 3-6). In other words, rather than run subsequent optimization operations on a massive base, the size of the group is much smaller. In some embodiments, the initial nanosegmentation process can be run without any historical data for a given campaign; however, once the system has performed at least a first cycle through each of the four layers, additional optimization of the nanosegments can be performed based on the outcomes and/or data for similar campaigns.

As a general matter, nanosegmentation can be used to establish customer nanosegments. As one non-limiting example, there may be 6-9 groups of customers that are used to drive the campaign strategy and design. The customer nanosegments may be created based on similar characteristics among a plurality of customers. Nanosegmentation can initially be based on a random sample set of customer records extracted through the CAR data. Simply as an example, the data extracted from the database may be for approximately thirty (30) million customers, yet the nanosegmentation may be performed only on a percentage, for example, ten (10) percent, of the customer records. Therefore, nanosegmentation may be performed for three (3) million customer records instead of thirty (30) million. These three (3) million customer records can be randomly selected, however, any manner of selecting the customer records may be used. Although a fewer number of customer records may be used for nanosegmentation, by using a random sample set of a percentage of customer records, a fairly accurate depiction of the customers may still be obtained.

In different embodiments, once the customer nanosegments have been defined, the system can determine their profiles in terms of behavior, value, and possibly demographic, lifestyle and life-stage data. This allows the business users to optionally understand and “name” the nanosegments. A sample nanosegmentation profile can include nanosegments that have been defined with customers having mortgages only, big savers, small savers, normal savers, new customers, and entrenched customers. Each nanosegment can be described through a description, percentage of sample population falling within the nanosegment, a lift value, asset accounts, loan accounts, tenure, transaction activity, demographics, etc.

In some embodiments, after segmenting the customer records, a marketing campaign may be defined for one or more customer nanosegments based on information known about the customers in the nanosegment. For example, a “lift value” may indicate a likelihood for a customer nanosegment to redeem an offer. The lift value may be calculated by dividing a number of accounts held by a predetermined number of customers divided by the number of customers. The lift value provides a factor that may be used to target specific nanosegments and reduce the total number of customers to whom an offer is to be communicated. A reduction in costs is achieved because fewer telephone calls or mailings are necessary to achieve substantially the same or higher response. For example, if a marketing campaign results in 100 new accounts for a bank out of the 1,000,000 customers contacted with the marketing offer, 0.0001 is the calculated lift. By using generative AI in the disclosed embodiments, 100 new accounts may be opened by contacting just the 400,000 customers most likely to respond (as determined by the model) and tailoring the content of the offer to each person in the nanosegment.

Moving now to FIG. 3, in some embodiments, the nanosegments that have been selected can be received by a second module 300 (also referred to herein as an optimization layer). In some embodiments, predictive models may be created when a marketing campaign is initially created and its objectives defined. As an example, a marketing campaign may be run by communicating offers to the customers through a customer interaction. The customer interaction may be, for example, a telephone call to the home of a customer or a mailing of an offer to the customer's home. Predictive models can also be developed using statistical methods like logistic regression, data mining technologies, neural nets, decision trees, etc. Prescriptive models may be defined and executed to determine which of these offers to provide and which specific customers in each segment should be targeted. After the first cycle of a campaign is executed, the predictive model may be trained using insight obtained from the first cycle and previous marketing campaigns, as described below.

In some examples, the nanosegments can be optimized, for example based on acceptance rates and cost of running the optimization, to improve targeting outcomes and generate learnings. In one example, the cost of the optimization can affect the initial optimization operation, while in later cycles where the optimization operation is repeated, acceptance rates from previous rounds may be used to shape the optimizations. In different embodiments, the system can employ a multi-tiered optimization algorithm 302 (e.g., using linear programming techniques). In a first stage or tier, the algorithm has an object function directed to minimizing the cost to the business per offer, determined with reference to constraints such as but not limited to an event rate (result data) for action taken/conversion (offer is accepted or otherwise leads to a purchase), an estimated average revenue per user, an average household income range, customer age, usage variables, customer response to previous campaigns, etc. In a second stage or tier, the algorithm has an object function directed to maximizing acceptance/event rates, as captured in previous optimization cycle(s), determined with reference to constraints such as but not limited to cost per offer, estimated average revenue per user, average household income range, customer age, usage variables, response to previous campaigns, etc.

For purposes of illustration, a first group 310 of nanosegments are depicted in FIG. 3, where each nanosegment is associated with a specific offer. In this example, the first group 310 includes a first set of shortlisted nanosegments for a first offer, a second set of shortlisted nanosegments for a second offer, a third set of shortlisted nanosegments for a third offer, and etc. based on the number of appropriate offers from a particular campaign (which can depend on the customer profiles for each of the nanosegments). In some embodiments, the second module 300 can identify and select, from each of the sets of shortlisted nanosegments, one or more customers in the top “X” decile (customer selection sets 320) that represent the system's determination regarding the best suited nanosegments based on the objectives selected by the business and associated constraints. As one non-limiting example, a constraint could refer to a size (consumer base) that a given campaign is seeking to target.

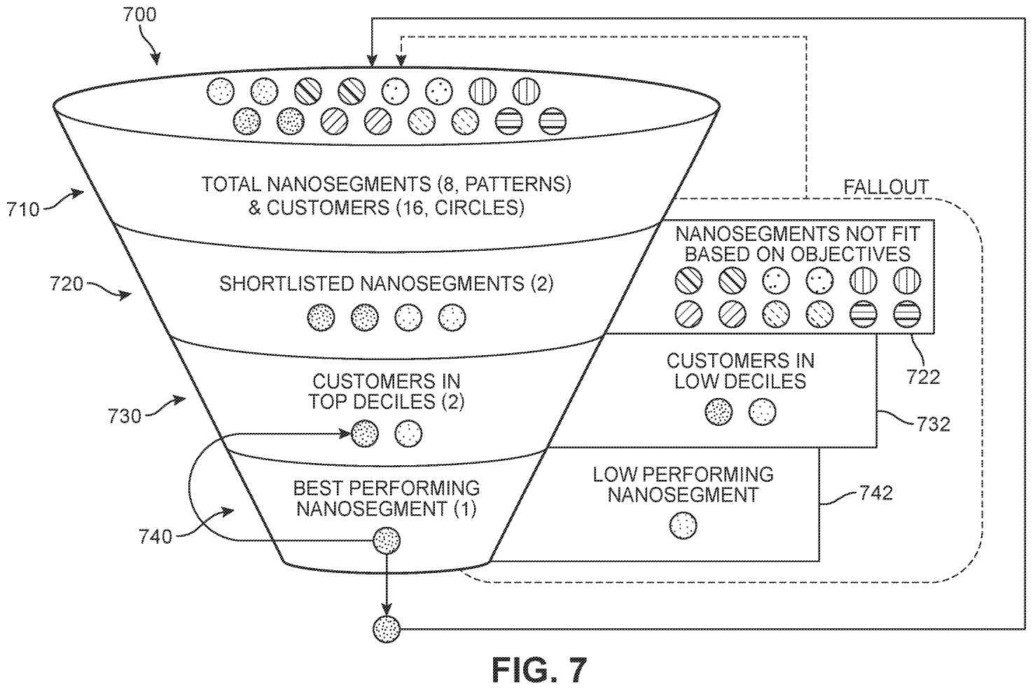

Referring briefly to FIG. 7, simply for purposes of illustration, a flow diagram visually depicts the shortlisting or iterative funneling process performed by the optimization layer. At a first stage 710, a first group of nanosegments (in this case, eight) are identified and created, for example by the nanosegment layer. In this case, each nanosegment includes two customers (each set of two customers (nanosegment) being represented by the same cross-hatching style) so there are 16 persons represented in eight nanosegments, though in other embodiments the number of customers/nanosegment can vary (e.g., 80-100 customers/nanosegment). In some embodiments, the optimization layer receives these eight nanosegments and performs a shortlisting process at a second stage 720, selecting only those nanosegments that match the optimization parameters provided. In this case, only two nanosegments remain (corresponding to four customers) are deemed as matching the campaign objectives, while a first level fallout group 722 is filtered out or rejected by the system. Analytical models are overlaid on the shortlisted nanosegments, and in a third stage 730, only those customers in the shortlisted nanosegments that match the objectives better than the other customers (i.e., fall in the top deciles) are selected, while a second fallout group 732 is filtered out or rejected by the system. Performance of the campaign is measured and compared for the specifically selected customers of the third stage 730, and the system then identifies and selects only the best performing nanosegment and/or customer(s) across the nanosegments and selects these nanosegments/customer(s) for retention in a fourth stage 740 (removing a third fallout group 742). This process is repeated as contact variable insights and profiling variable insights are generated and used to refine and improve the operation of the propensity model at the first stage 710.

In some embodiments, predictive modeling techniques as described herein can be used to prioritize leads in each nanosegment and further narrow down or fine-tune the persons to be targeted by the campaign. For purposes of this application, a “lead” may refer to a person, business, or entity may develop into a potential customer or client. A “lead” may also refer to data associated with a person, business, or entity that may leads to a sale of a product or service. In some embodiments, once the customers in a given nanosegment have been prioritized, a top decile or set of the higher deciles can be selected to form a subset of the nanosegment.

In other words, as the funneling process takes place, the system can iteratively remove some nanosegments from its original nanosegment delegation to optimize for performance. As the system learns more about which customer base is most successfully targeted, and which was least successfully targeted, by the current campaign and re-build or re-train the propensity model. For example, for each nanosegment, there are propensities that are identified and can be used to fine-tune the contact strategy (re-targeting). In some embodiments, the original set of nanosegments can be curated, and in other embodiments, entirely different nanosegments can be defined based on the insights/repository data and the whole process can be performed again. For the insights that we have learned right, that is going again back to our historical campaign and nanosegment performance repository. In one embodiment, the data in the repository from the most recent/past cycle(s) can be used to determine model weights for the next cycle. As each cycle is run and more data is collected for re-learning, the system shifts from random probabilities in its predictions to an increasingly accurate prediction.

Thus, returning to FIG. 3, it can be appreciated that in different embodiments, the optimization layer can employ AI and ML models to determine a propensity of a particular action by the customer against a specific offer of a given campaign. The determined propensity can then be overlaid on the nanosegments that have been selected for that particular campaign. For example, if three nanosegments have been selected or identified for one offer, an output of a ML propensity model will be overlaid on these nanosegments, and this combined information used to select the customers. In other words, there can be a shift from targeting nanosegments to targeting individual consumers at this stage. In some embodiments, an optimization is performed for each available offer in the campaign for which the system is currently assessing.

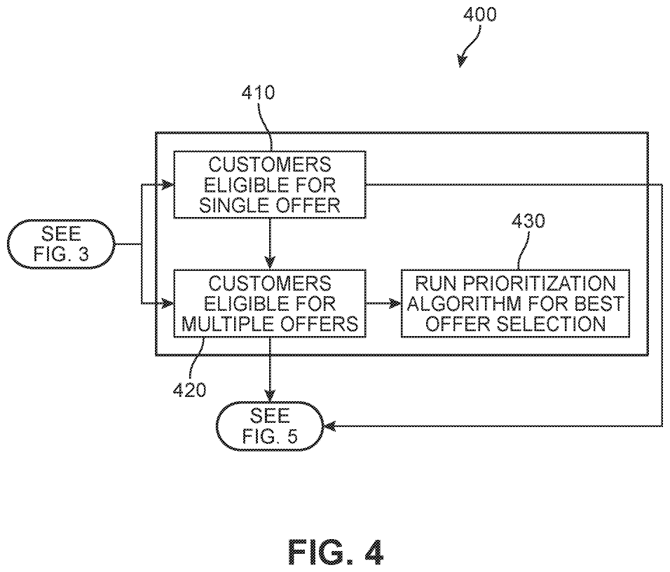

In some embodiments, the second module 300 of FIG. 3 can optimize the objective defined for the selected campaign at the offer level. For example, for each campaign, an objective will be defined based on an “objective function” which initially corresponds to the minimized cost per offer (with event rate as constraint) is minimized, and subsequently corresponds to the maximized acceptance/event rate captured during successive optimizations. In some embodiments, out of a total of “X” nanosegments and based on the optimization results, clusters of nanosegments are shortlisted for each offer. The customers from the top “Y” deciles (as designated by the business or identified in the objectives) are selected to conform to the pre-defined targeting size. Customers eligible for a single offer can then be directly targeted, while customers eligible for multiple offers are run through the prioritization algorithm for best offer selection (e.g., see FIG. 4).

Moving next to FIG. 4, in some embodiments, a third module 400 (also referred to herein as a singleton offer layer) can filter the top customers into two groups including customers eligible for a single offer 410, and customers eligible for multiple offers 420. In other words, there may be customers in the selected top customers for whom multiple offers from a single marketing campaign are designated as appropriate (e.g., one offer is giving $100 off, another offer is giving $50.00 off, and a third offer is giving $200 off). Though providing different values, each offer is directed to the same action or campaign, increasing a likelihood that some of the offers include aspects that overlap with one another. It can be appreciated that it is desirable to provide only one of these offers to a specific customer, rather than two or more, in the context of a single campaign. For those customers eligible for multiple offers 420, a prioritization algorithm can be run to select the best-suited offer for each of these customers. In different embodiments, the prioritization algorithm combines cost, the acceptance of that offer, and the advantages or benefit of the offer that will be experienced by the customer to computationally determine the best offer for a customer.

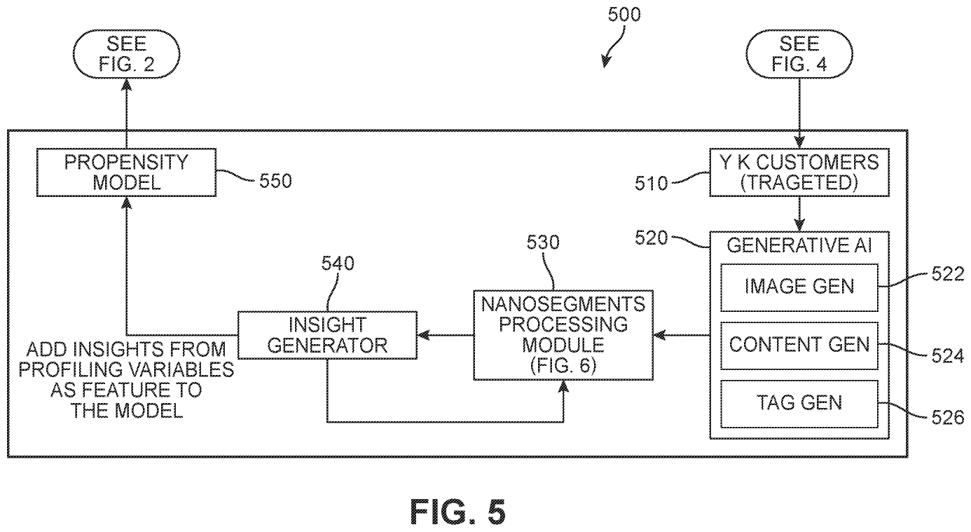

As shown in FIG. 5, the selected customers (“Y”)—and their specific assigned (single) offer (“K”)—can then be outputted and received by a generative AI module 520 of a fourth module 500 (also referred to as an insight generation layer) as Y-K customers 510. The generative AI module 520 can receive this input and information about the preferred outbounding channel (e.g., e-mail, text, web, etc.) and intelligently determine specific aspects of the offer to be presented in an outbound campaign to the targeted customer(s). in some embodiments, the generative AI module 520 employs one or more large language model (LLM) to generate the most appropriate offer tagline, content/language, and images. As a general matter, an LLM can refer to a type of machine learning model that can perform a variety of natural language processing (NLP) tasks, including generating and classifying text, answering questions in a conversational manner and translating text from one language to another.

In different embodiments, the generative AI module 520 can receive inputs such as a campaign type (label or classification), previous campaign content, responses to previous content shared, etc. The generative AI module 520 can be understood to employ multiple algorithms in order to produce appropriate generative image(s) 522, generative content 524, and/or generative tagging 526. In some embodiments, the generative AI module 520 can be trained using historical campaign data—for example, images from past campaigns will be used by a first algorithm (e.g., DALL-e, or a deep learning model developed by OpenAI to generate digital images from natural language descriptions, called “prompts”) of the generative AI module 520 to learn what image should be generated now, in the context of a highly targeted and personalized customer identity and profile. Similarly, a second algorithm (e.g., a BERT (Bidirectional Encoder Representations from Transformers) LLM model, developed by Google® and trained on a large corpus of text data that can understand the context of a sentence and generate meaningful responses to questions) can be further trained on historical campaign content. Furthermore, a third algorithm (e.g., a GPT-3 (Generative Pretrained Transformer 3) LLM developed by OpenAI with over 175 billion parameters that can perform many tasks, including text generation, translation, and summarization) can be trained using tags from historical campaign data. The historical campaign data will be curated before being passed to the algorithms, to ensure the targeted customer preferences and objectives of the current campaign are being served. The generative AI module 520 can then collectively generate contextually relevant, shareable taglines, textual content, and images representing specific promotional content for an offer that is to be shared via various preferred channels throughout the campaign's duration.

Thus, in some embodiments, the system employs AI-based design generation and validation that can incorporate or digest previous marketing offer designs or presentation styles and generate elements that have a more visually-appealing design or layout for a specifically targeted customer, without involving further manual input. For example, a generative AI engine of the system may be trained on historical campaign elements, such as data that may include any type of graphic element, such as an image (e.g., of a flyer, magazine, etc.), a screenshot (e.g., of a website), or other similar graphic element. The data may also include a uniform resource locator (URL) of a website, a list of discrete elements, or other similar input. The data received may also be passed to other components for processing prior to design generation or evaluation or performing analytics. In some embodiments, if the data is an existing design, picture, or document, the system can preprocess the training data to split the design, picture, or document into a list of elements. For example, the segmentation may optical character recognition (OCR) techniques to help transform image into text and/or leverage AI-based techniques, e.g., semantic segmentation, Tensorflow, etc.

In some embodiments, using AI-based design generation and validation techniques, the generative AI engine can adjust various positional elements, dimensions, colors, effects, etc. and generate variations of a design or layout for the target customer. These techniques may include a convolutional neural network (CNN) for visual saliency prediction trained with generative adversarial networks. In some examples, the machine learning or AI-based techniques may involve clustering, classification, pattern mining, logistic regression, decision tree, random forest, semantics, knowledge graph analysis, and/or other techniques.

The number of designs created and presented to customers may far exceed what a human designer or design team could do in the same amount of time. In one example, the system may be configured to create a design or layout “on the fly,” which may be specified to a particular consumer demographic, location, context, or other related consumer grouping or profile, maintaining an aesthetically-pleasing design or layout in a very expedient manner, while learning from performance of any previously generated and/or validated design or layout and use that information for refining the design or layout or for other consumers that match or have a similar consumer profile.

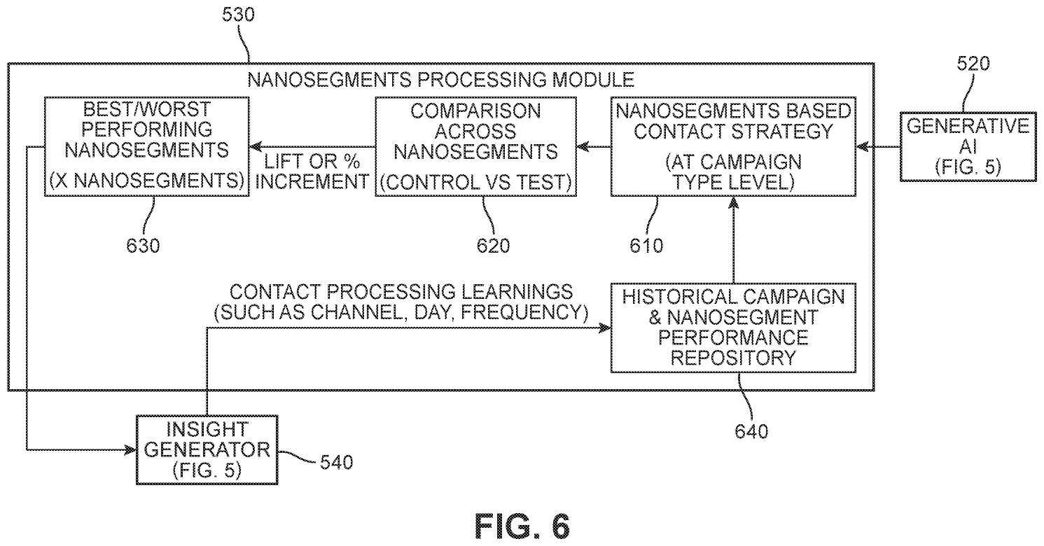

In different embodiments, the output of the generative AI module 520 can be received by a nanosegments processing module 530 which is shown in greater detail in FIG. 6. In a first example, a nanosegment-based contact strategy can be developed (e.g., at the campaign-type level), with reference to knowledge stored in and accessible via a historical campaign and nanosegment performance repository (“repository”) 640 that will be managed with historical as well as real-time insights. Based on features and contact insights, the repository can be updated for each nanosegment. In some embodiments, key characteristics of the nanosegments selected based on performance can then be used as inputs in the next step to identify similar nanosegments. In the case of a new campaign, there may not yet be information stored against each nanosegment, and so default or baseline values may be substituted until enough data has been collected. A contact strategy can be developed with the goal of improving the individual customer's experience and/or reduce customer fatigue that may cause the customer to opt-out from the proffered marketing experiences.

Thus, the system can use insight(s) developed from prior campaigns to update repository 640. These insights can be based on marketing operations performance data such as the number of offers redeemed, which customers redeemed the offer, the time elapsed between the offer presentation and redeeming of the offer, and other information. The repository 640 may then be updated automatically with the results of the marketing campaign cycle. This update may be done via a series of SQL update statements, for example. The marketing campaign results provide insight regarding a customer's behavior toward redeeming offers. The insight may be, for example, what types of offers a customer is likely to accept, which customers are more inclined to accept an offer, how quickly a customer redeems an offer, etc. This information may be used to refine further customer interactions to increase the number of offers accepted. Thus, through the interaction with the customer, insight (knowledge) is gained that is used to improve future interactions, such as marketing campaigns. This may be performed by repeating the steps of the method for adaptive marketing using insight driven customer interaction. Based on new customer data extracted (including part or all of the updated data that is the insight gained from the prior interaction), the predictive model may be trained resulting in a more accurate picture of anticipated customer responses to marketing offers. The adaptive model is usually developed to support each new campaign. Due to the rapidity of model development, enabled by this process, models can be developed to support each new campaign, then re-trained (adapted) to provide a mid-campaign correction if necessary. This process may be repeated for any desired number of customer interactions.

In different embodiments, the current contact strategy can be used by the nanosegments processing module 530 to compare nanosegments (comparison step 620), and based on the comparison, determine the best and/or worst performing nanosegments (ranking step 630). In some embodiments, the output of the comparison serves as an indicator of how effective the targeting during the previous marketing cycle(s) were. In one example, the comparison is made between a control group and a test group to whom campaign offers have been sent. The output is provided to an insight generator 540, which can produce insights that are used to continue to update and replenish information stored in the repository 640. For example, insights can include content process learnings such as types of communication channels, days, frequency of contact, time of contact or delivery time of contact (e.g., weekend, weekday, morning, afternoon, evening, etc.) that reflect derived data associated with the best performing nanosegments. In some embodiments, the insights are used to make adjustments to the profiling variables or other variables that will be used to help define nanosegments and contact strategy in the next marketing cycle and can be used to fine-tune the presentation elements to better correspond to each customer's preferred offer layout and design as the campaign progresses. In some embodiments, a matrix including variables such as lift and percent increment can be used to compare the nanosegments across the control group and the test group. Better performing nanosegments can then be identified from the shortlisted nanosegments (“X” nanosegments in FIG. 6) for input to the insight generator 540.

Returning to FIG. 5, the insights for each nanosegment generated by the insight generator 540 (e.g., including insights associated with the profiling and other contact variables) can be shared with a propensity model 550 to be used as new features by the propensity model as a form of optimization to maximize probability and the likelihood of accurate predictions for the target customers. In some embodiments, the propensity model 550 is built at the nanosegment level to determine or predict the probability for an offer acceptance or rejection event by a customer. In some embodiments, the propensity model 550 can include a Bayesian Neural Network (BNN) which incorporates a stochastic artificial neural network trained using Bayesian inference. The Bayesian approach, based on statistical methodologies, generates a probability distribution for each variable, including model parameters. In different embodiments, the propensity model 550 can determine a probability of an event occurring based on features harvested using insights derived from the profiling variables, such as but not limited to the customer's response to previous offers/campaign, their choice of device, the customer's last action taken with respect to the event categories, the time since the action was taken (recency), and/or the frequency of positive response to campaigns generally by the customer. This model can then be used to update the operation of the first module 200 (see FIG. 2) and improve system performance and in particular, the accuracy of the nanosegment clustering/classifications (e.g., see FIG. 2). In some embodiments, the repository 640 (see FIG. 6) can also be updated with insights based on the contact variables, which can be used to define the contact strategy for the selected customer base.

As described herein, the proposed systems are designed to identify nanosegments of customers that may be appropriate target recipients of offers for a specific campaign. With each run-through (marketing cycle) performed by the system, the nanosegments are revised and fine-tuned to increasingly correspond to (e.g., predictions made with a greater probability) and more closely represent the best-fit audience for the offer(s). This iterative optimizing is used to narrow the target in a process that significantly reduces the costs to the business, as fewer offers may be generated, but each of these offers are now tailor-made for each customer using generative AI to elicit the most positive outcomes. The insights gained during each cycle can then be maintained in the repository and used not only in subsequent cycles of the same campaign, but in future campaigns with similar objectives. The proposed systems have been observed to bolster targeting accuracy of around 5-8% for each loop through the cycle. In this way, the contact strategy can be refined, including the selected communication channel that is used, and the type of information presented in the offer to a customer, to be optimally suited to the nanosegment. For example, the generative AI can determine one presentation mode (i.e., with a first content, a first image, and a first tag) for an offer is best suited to young people under 25, while a second presentation mode (i.e., with a second content, a second image, and a second tag) of another offer for the same campaign is best suited to people between 25 and 45, and/or men vs. women, etc., across other demographic and behavioral profiles. In some embodiments, the system can curate its target base to the objectives of a campaign based on customer profile data such as the birth of a child, a new home purchase, attending a new educational program, getting a new job, or other significant life event. In some cases, customers may be more receptive to a campaign based on the occurrence of such an event. Furthermore, in some embodiments, the system can leverage its generative AI tools to tailor product and service offerings to a particular customer. While traditional marketing campaigns rely on static data, for example, CRM data, which is typically aggregated and sent to a marketing team to develop a particular marketing campaign, the proposed systems may allow for marketing campaigns that are both contextually responsive and temporally relevant.

In some embodiments, the proposed systems may implement various AI-based machine learning, including clustering, modeling, simulation, predictive analytics, knowledge graphs, as well as various other statistical or data-driven approaches, such as decision trees, etc., to help build and create insights for its repository, which may further be used to improve customer or product support, and lower risk to an organization entity by reducing cumbersome processes and enhancing efficiency for both an organization and its clients.

It can be appreciated that such a hyper-personalized approach can greatly reduce opt-out requests by customers while increasing customer satisfaction. Because the process is interwoven with explainability components, the business will also be able to understand why the system may choose one presentation mode over another presentation mode with respect to a particular nanosegment, and/or why a specific nanosegment may be selected for a given campaign or offer. Although techniques and architectures are discussed in terms of customer interaction, the architectures and techniques may be applied in various contexts such as logistics, business intelligence, market analysis, or analysis in other fields. The architectures and techniques may be applied in virtually any field where personalized content is desired that incorporates real-time or near-real-time analytics.

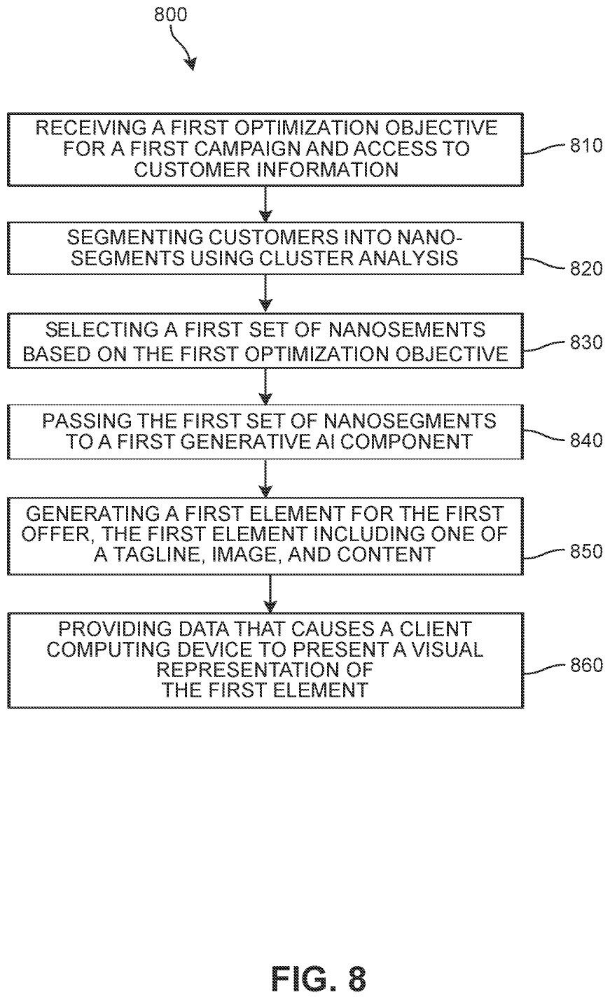

FIG. 8 is a flow chart illustrating an embodiment of a method 800 for optimizing marketing campaign offers. The method 800 includes a first step 810 of receiving, by a processor, a first optimization objective for a first campaign and access to customer information (e.g., in a database, such as the CARs described above), and a second step 820 of segmenting/grouping, by the processor, customers identified or otherwise provided in the customer information into a plurality of nanosegments using a cluster analysis algorithm that identifies clusters in the customer information based on similar characteristics. A third step 830 includes selecting, by a machine learning (ML) optimization model and based on the first optimization objective, a first set of nanosegments from the plurality of nanosegments for inclusion in the first campaign, where each of the nanosegments includes or identifies one or more customers. A fourth step 840 includes passing, from the processor, the first set of nanosegments to a first generative artificial intelligence (AI) component, and a fifth step 850 includes automatically generating, via the first generative AI component, digital content including a first element for a first offer in response to the customer information for only the first set of nanosegments, the first element including one of a tagline, image, and content. The method 800 also includes a sixth step 860 of providing, to a first client computing device, first data that causes the first client computing device to present a visual representation of the first element as part of the first offer, the first client computing device being associated with a first customer identified in the first set of nanosegments.

In other embodiments, the method may include additional steps or aspects. In another example, the method further includes a step of prioritizing leads in the first nanosegment using a predictive modeling technique, wherein the predictive modeling technique comprises at least one of iterative propensity modeling, optimization, and segmentation. In another example, the method further includes receiving, at the processor, results data for the first offer after presentation to the first customer, and training, based on the results data, an ML propensity model at a nanosegment level to find a probability for a conversion event in which the first customer accepts the first offer. For example, training can allow for iterative improvements for future functions based on propensity. Thus, at each cycle of the campaign where an offer is created by the generative AI component and a result determined and collected, the outcome is applied to the subsequent cycle by the updating, refining, and retraining of the propensity model.

In some embodiments, the method can also include steps of passing, from the processor, the first set of nanosegments to a second generative AI component; automatically generating, via the second generative AI component, digital content including a second element for the first offer in response to the customer information for only the first set of nanosegments, the second element including one of a tagline, image, and content; and providing, to the first client computing device, second data that causes the first client computing device to present a visual representation of the second element in the first offer along with the first element. In another embodiment, the method may include additional steps of passing, from the processor, the first set of nanosegments to a third generative AI component; automatically generating, via the third generative AI component, a third element for the first offer in response to the customer information for only the first set of nanosegments, the third element including one of a tagline, image, and content; and providing, to the first client computing device, third data that causes the first client computing device to present a visual representation of the third element in the first offer along with the first element and the second element.

In some embodiments, the method can further include steps of receiving, by a processor, a second optimization objective for a second campaign that differs from the first optimization objective; selecting, by the ML optimization model and based on the second optimization objective, a second set of nanosegments from the plurality of nanosegments for inclusion in the second campaign; passing, from the processor, the second set of nanosegments to the first generative AI component; automatically generating, via the first generative AI component, digital content including a second element for the first offer in response to the customer information for only the second set of nanosegments, the second element including one of a tagline, image, and content and differing from the first element; and providing, to a second client computing device, second data that causes the second client computing device to present a visual representation of the second element as part of the second offer, the second client computing device being associated with a second customer identified in the second set of nanosegments. In another example, the method also includes receiving, at the processor, results data for the first offer after presentation to the first customer; and training, based on the results data, the first generative AI component based on the results data to improve subsequent element generation. In other words, in some embodiments, historical data from previous campaigns in which event outcomes were positive (e.g., conversions, repeat purchases, high customer experience, etc.) can be fed to the AI component to improve selection and identification of which type of tagline, image, or content to use in subsequent offers. In still other examples, the method can include steps of selecting those customers in the first nanosegment that are in a first decile of the prioritized leads to form a first subset; and implementing, by the processor, a first artificial intelligence (AI) component to identify a first set of common attributes based on the customer information for customers in the first subset.

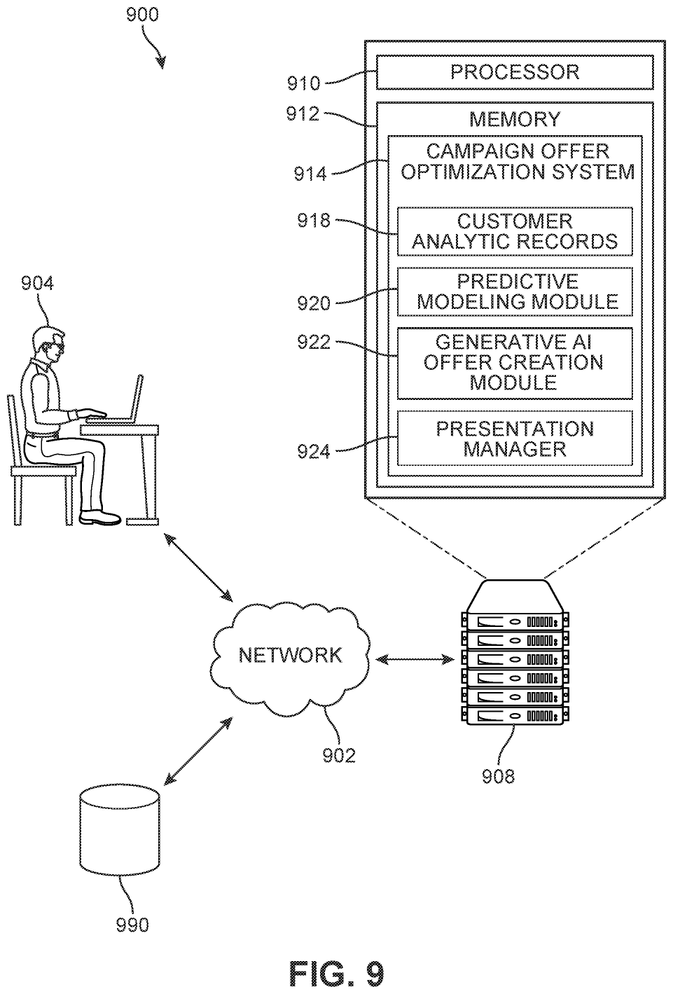

FIG. 9 is a schematic diagram of an environment 900 for a campaign offer optimization system 914 (or system 914), according to an embodiment. The environment 900 may include a plurality of components capable of performing the disclosed methods. For example, environment 900 includes a user device 904, a computing/server system 908, and a database 990. The components of environment 900 can communicate with each other through a network 902. For example, user device 904 may retrieve information from database 990 via network 902. In some embodiments, network 902 may be a wide area network (“WAN”), e.g., the Internet. In other embodiments, network 902 may be a local area network (“LAN”).

As shown in FIG. 9, components of the system 914 may be hosted in computing system 908, which may have a memory 912 and a processor 910. Processor 910 may include a single device processor located on a single device, or it may include multiple device processors located on one or more physical devices. Memory 912 may include any type of storage, which may be physically located on one physical device, or on multiple physical devices. In some cases, computing system 908 may comprise one or more servers that are used to host the system.

While FIG. 9 shows one user device, it is understood that one or more user devices may be used. For example, in some embodiments, the system may include two or three user devices. In some embodiments, the user device may be a computing device used by a user. For example, user device 904 may include a smartphone or a tablet computer. In other examples, user device 904 may include a laptop computer, a desktop computer, and/or another type of computing device. The user devices may be used for inputting, processing, and displaying information. Referring to FIG. 9, environment 900 may further include database 990, which stores repository data, model training data, insights, customer records, previous marketing campaign data, and/or other related data for the components of the system as well as other external components. This data may be retrieved by other components for system 914. As discussed above, system 914 may include access to customer analytic records 918, a predictive modeling module 920, a generative AI offer creation module 922, and a presentation manager 924 for conveying the created offer to the prospective customer(s) via the designated channel. Each of these components may be used to perform the operations described herein.

Embodiments of the proposed systems and methods can also incorporate components, features, aspects, and other details described in U.S. Pat. No. 7,707,059 to Kenneth L. Reed et al., granted on Apr. 27, 2010 “Adaptive marketing using insight driven customer interaction”, which is herein incorporated by reference in its entirety.

For purposes of this application, an “interface” may be understood to refer to a mechanism for communicating content through a client application to an application user. In some examples, interfaces may include pop-up windows that may be presented to a user via native application user interfaces (UIs), controls, actuatable interfaces, interactive buttons/options or other objects that may be shown to a user through native application UIs, as well as mechanisms that are native to a particular application for presenting associated content with those native controls. In addition, the terms “actuation” or “actuation event” refers to an event (or specific sequence of events) associated with a particular input or use of an application via an interface, which can trigger a change in the display of the application. Furthermore, a “native control” refers to a mechanism for communicating content through a client application to an application user. For example, native controls may include actuatable or selectable options or “buttons” that may be presented to a user via native application UIs, touch-screen access points, menus items, or other objects that may be shown to a user through native application UIs, segments of a larger interface, as well as mechanisms that are native to a particular application for presenting associated content with those native controls. The term “asset” refers to content that may be presented in association with a native control in a native application. As some non-limiting examples, an asset may include text in an actuatable pop-up window, audio associated with the interactive click of a button or other native application object, video associated with the user interface, or other such information presentation.

It should be understood that the text, images, and specific application features shown in the figures are for purposes of illustration only and in no way limit the manner by which the application may communicate or receive information. In addition, in other embodiments, one or more options or other fields and text may appear differently and/or may be displayed or generated anywhere else on the screen(s) associated with the client's system, including spaced apart from, adjacent to, or around the user interface. In other words, the figures present only one possible layout of the interface, and do not in any way limit the presentation arrangement of any of the disclosed features.

Embodiments may include a non-transitory computer-readable medium (CRM) storing software comprising instructions executable by one or more computers which, upon such execution, cause the one or more computers to perform the disclosed methods. Non-transitory CRM may refer to a CRM that stores data for short periods or in the presence of power such as a memory device or Random Access Memory (RAM). For example, a non-transitory computer-readable medium may include storage components, such as, a hard disk (e.g., a magnetic disk, an optical disk, a magneto-optic disk, and/or a solid state disk), a compact disc (CD), a digital versatile disc (DVD), a floppy disk, a cartridge, and/or a magnetic tape.

To provide further context, in some embodiments, some of the processes described herein can be understood to operate in a system architecture that can include a plurality of virtual local area network (VLAN) workstations at different locations that communicate with a main data center with dedicated virtual servers such as a web server for user interfaces, an app server for OCR and data processing, a database for data storage, etc. As a general matter, a virtual server is a type of virtual machine (VM) that is executed on a hardware component (e.g., server). In some examples, multiple VMs can be deployed on one or more servers.

In different embodiments, the system may be hosted at least in part in a cloud computing environment offering ready scalability and security. The cloud computing environment can include, for example, an environment that hosts the document processing management service. The cloud computing environment may provide computation, software, data access, storage, etc. services that do not require end-user knowledge of a physical location and configuration of system(s) and/or device(s) that hosts the policy management service. For example, a cloud computing environment may include a group of computing resources (referred to collectively as “computing resources” and individually as “computing resource”). It is contemplated that implementations of the present disclosure can be realized with appropriate cloud providers (e.g., AWS provided by Amazon™, GCP provided by Google™, Azure provided by Microsoft™, etc.).

The methods, devices, and processing described above may be implemented in many different ways and in many different combinations of hardware and software. For example, all or parts of the implementations may be circuitry that includes an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof.

While various embodiments of the invention have been described, the description is intended to be exemplary, rather than limiting, and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

We claim:

1. A method for generating digital content, the method comprising:
receiving, by a processor, a first optimization objective for a first campaign and access to customer information;
segmenting, at the processor, customers identified in the customer information into a plurality of nanosegments using a cluster analysis algorithm that identifies clusters in the customer information based on similar characteristics and predefined rules;
selecting, by a machine learning (ML) optimization model and based on the first optimization objective, a first set of nanosegments from the plurality of nanosegments for inclusion in the first campaign;
passing, from the processor, the first set of nanosegments to a first generative artificial intelligence (AI) component;
automatically generating, via the first generative AI component, digital content including a first element for a first offer in response to the customer information for only the first set of nanosegments, the first element including one of a tagline, image, and content; and
providing, to a first client computing device, first data that causes the first client computing device to present a visual representation of the first element as part of the first offer, the first client computing device being associated with a first customer identified in the first set of nanosegments.

2. The method of claim 1, further comprising prioritizing leads in the first nanosegment using a predictive modeling technique, wherein the predictive modeling technique comprises at least one of iterative propensity modeling, optimization, and segmentation.

3. The method of claim 1, further comprising:
receiving, at the processor, results data for the first offer after presentation to the first customer; and
training, based on the results data, an ML propensity model at a nanosegment level to find a probability for a conversion event in which the first customer accepts the first offer.

4. The method of claim 1, further comprising:
passing, from the processor, the first set of nanosegments to a second generative AI component;
automatically generating, via the second generative AI component, digital content for a second element for the first offer in response to the customer information for only the first set of nanosegments, the second element including one of a tagline, image, and content; and
providing, to the first client computing device, second data that causes the first client computing device to present a visual representation of the second element in the first offer along with the first element.

5. The method of claim 4, further comprising:
passing, from the processor, the first set of nanosegments to a third generative AI component;
automatically generating, via the third generative AI component, a third element for the first offer in response to the customer information for only the first set of nanosegments, the third element including one of a tagline, image, and content; and
providing, to the first client computing device, third data that causes the first client computing device to present a visual representation of the third element in the first offer along with the first element and the second element.

6. The method of claim 1, further comprising:
receiving, by the processor, a second optimization objective for a second campaign that differs from the first optimization objective;
selecting, by the ML optimization model and based on the second optimization objective, a second set of nanosegments from the plurality of nanosegments for inclusion in the second campaign;
passing, from the processor, the second set of nanosegments to the first generative AI component;
automatically generating, via the first generative AI component, digital content including a second element for the second offer in response to the customer information for only the second set of nanosegments, the second element including one of a tagline, image, and content and differing from the first element; and
providing, to a second client computing device, second data that causes the second client computing device to present a visual representation of the second element as part of the second offer, the second client computing device being associated with a second customer identified in the second set of nanosegments.

7. The method of claim 1, further comprising:
receiving, at the processor, results data for the first offer after presentation to the first customer; and
training, based on the results data, the first generative AI component based on the results data to improve subsequent element generation.

8. The method of claim 7, further comprising:
automatically generating, via the trained first generative AI component, digital content including a second element for the first offer in response to the customer information for only the first set of nanosegments, the second element including one of a tagline, image, and content and differing from the first element; and
providing, to a second client computing device, second data that causes the second client computing device to present a visual representation of the second element as part of the first offer, the second client computing device being associated with a second customer identified in the first set of nanosegments.

9. A non-transitory computer-readable medium storing software comprising instructions for generating digital content executable by one or more computers which, upon such execution, cause the one or more computers to:
receive, by a processor, a first optimization objective for a first campaign and access to customer information;
segment, at the processor, customers identified in the customer information into a plurality of nanosegments using a cluster analysis algorithm that identifies clusters in the customer information based on similar characteristics and predefined rules;
select, by a machine learning (ML) optimization model and based on the first optimization objective, a first set of nanosegments from the plurality of nanosegments for inclusion in the first campaign;
pass, from the processor, the first set of nanosegments to a first generative artificial intelligence (AI) component;
automatically generate, via the first generative AI component, digital content including a first element for a first offer in response to the customer information for only the first set of nanosegments, the first element including one of a tagline, image, and content; and
provide, to a first client computing device, first data that causes the first client computing device to present a visual representation of the first element as part of the first offer, the first client computing device being associated with a first customer identified in the first set of nanosegments.

10. The non-transitory computer-readable medium storing software of claim 9, wherein the instructions further cause the one or more computers to prioritize leads in the first nanosegment using a predictive modeling technique, wherein the predictive modeling technique comprises at least one of iterative propensity modeling, optimization, and segmentation.

11. The non-transitory computer-readable medium storing software of claim 9, wherein the instructions further cause the one or more computers to:
receive, at the processor, results data for the first offer after presentation to the first customer; and
train, based on the results data, an ML propensity model at a nanosegment level to find a probability for a conversion event in which the first customer accepts the first offer.

12. The non-transitory computer-readable medium storing software of claim 9, wherein the instructions further cause the one or more computers to:
pass, from the processor, the first set of nanosegments to a second generative AI component;
automatically generate, via the second generative AI component, digital content including a second element for the first offer in response to the customer information for only the first set of nanosegments, the second element including one of a tagline, image, and content; and
provide, to the first client computing device, second data that causes the first client computing device to present a visual representation of the second element in the first offer along with the first element.

13. The non-transitory computer-readable medium storing software of claim 12, wherein the instructions further cause the one or more computers to:
pass, from the processor, the first set of nanosegments to a third generative AI component;
automatically generate, via the third generative AI component, a third element for the first offer in response to the customer information for only the first set of nanosegments, the third element including one of a tagline, image, and content; and
provide, to the first client computing device, third data that causes the first client computing device to present a visual representation of the third element in the first offer along with the first element and the second element.

14. The non-transitory computer-readable medium storing software of claim 9, wherein the instructions further cause the one or more computers to:
receive, by the processor, a second optimization objective for a second campaign that differs from the first optimization objective;
select, by the ML optimization model and based on the second optimization objective, a second set of nanosegments from the plurality of nanosegments for inclusion in the second campaign;
pass, from the processor, the second set of nanosegments to the first generative AI component;
automatically generate, via the first generative AI component, digital content including a second element for the second offer in response to the customer information for only the second set of nanosegments, the second element including one of a tagline, image, and content and differing from the first element; and
provide, to a second client computing device, second data that causes the second client computing device to present a visual representation of the second element as part of the second offer, the second client computing device being associated with a second customer identified in the second set of nanosegments.

15. The non-transitory computer-readable medium storing software of claim 9, wherein the instructions further cause the one or more computers to:
receive, at the processor, results data for the first offer after presentation to the first customer; and
train, based on the results data, the first generative AI component based on the results data to improve subsequent element generation.

16. A system for generating digital content, the system comprising one or more computers and one or more storage devices storing instructions that are operable, when executed by the one or more computers, to cause the one or more computers to:
receive, by a processor, a first optimization objective for a first campaign and access to customer information;
segment, at the processor, customers identified in the customer information into a plurality of nanosegments using a cluster analysis algorithm that identifies clusters in the customer information based on similar characteristics and predefined rules;
select, by a machine learning (ML) optimization model and based on the first optimization objective, a first set of nanosegments from the plurality of nanosegments for inclusion in the first campaign;
pass, from the processor, the first set of nanosegments to a first generative artificial intelligence (AI) component;
automatically generate, via the first generative AI component, digital content including a first element for a first offer in response to the customer information for only the first set of nanosegments, the first element including one of a tagline, image, and content; and
provide, to a first client computing device, first data that causes the first client computing device to present a visual representation of the first element as part of the first offer, the first client computing device being associated with a first customer identified in the first set of nanosegments.

17. The system of claim 16, wherein the instructions further cause the one or more computers to prioritize leads in the first nanosegment using a predictive modeling technique, wherein the predictive modeling technique comprises at least one of iterative propensity modeling, optimization, and segmentation.

18. The system of claim 16, wherein the instructions further cause the one or more computers to:
receive, at the processor, results data for the first offer after presentation to the first customer; and
train, based on the results data, an ML propensity model at a nanosegment level to find a probability for a conversion event in which the first customer accepts the first offer.

19. The system of claim 16, wherein the instructions further cause the one or more computers to:
pass, from the processor, the first set of nanosegments to a second generative AI component;
automatically generate, via the second generative AI component, digital content including a second element for the first offer in response to the customer information for only the first set of nanosegments, the second element including one of a tagline, image, and content; and
provide, to the first client computing device, second data that causes the first client computing device to present a visual representation of the second element in the first offer along with the first element.

20. The system of claim 19, wherein the instructions further cause the one or more computers to:
pass, from the processor, the first set of nanosegments to a third generative AI component;
automatically generate, via the third generative AI component, a third element for the first offer in response to the customer information for only the first set of nanosegments, the third element including one of a tagline, image, and content; and
provide, to the first client computing device, third data that causes the first client computing device to present a visual representation of the third element in the first offer along with the first element and the second element.
